(19) United States
(12) Patent Application Publication
(10) Pub. No.: US 2004/0158555 A1
(43) Pub. Date: Aug. 12, 2004

(54) Method for managing a collection of media objects

(75) Inventors: Michael Seedman, Morton Grove, IL (US); Kevin B. Lacey, Oak Park, IL (US); Niels Clausen-Stuck, Chicago, IL (US)

Correspondence Address: GREENBERG TRAURIG, P.C., Suite 2500, 77 West Wacker Drive, Chicago, IL, 60601, US

(73) Assignee: Terradigtal Systems LLC.

(21) Appl. No.: 10/364,609

(22) Filed: Feb. 11, 2003

(51) Int. Cl. G06F 17/30; G11B 21/08

(52) U.S. Cl. 707/3; 369/30.08; 369/30.05; 369/30.19

(57) ABSTRACT

A method for managing the contents of a collection of media objects each having one or more identifying parameters. An image representative of a media object within the collection of media objects that is determined to have one or more specified identifying parameters is displayed. An image representative of a media object determined to be missing from the collection of media objects that is known to have the one or more specified identifying parameters is also displayed. In this manner, for example, a consumer may be informed of a need to add the media object determined to be missing from the collection of media object to the media object library.

### BACKGROUND OF THE INVENTION

This invention relates generally to electronic devices for playing media objects and, more particularly, relates to a graphical user interface for managing a collection of media objects, including digital audio files such as MP3 files, for use in connection with the operation of an electronic device.

In the case of at least digitally stored media objects, such as audio recordings, video recordings, etc., information about the digitally stored recordings is typically maintained within a database. Devices for playing the digitally stored recordings enable access to the digitally stored recordings, for example, by allowing a user to scroll through a list of information retrieved from the database typically presented as text, from which the consumer may then access a digitally stored recording of interest. However, as the amount of information within the database increases, consumers often time find that the information concerning the contents of their library of media objects is incomplete.

The advent of MP3 audio technology, MP3 players and the almost commonplace existence of personal computers has lead to an explosive growth in the number of users who maintain their collection of audio albums and compact discs (CD's) as digital files stored on media such as a computer hard drive. Entire collections of LP's and CD's can now be easily stored, accessed and played using commonplace computer hardware and software or any one of the increasingly available dedicated digital audio devices, such as an MP3 player or jukebox.

A CD typically comprises a plurality of individual songs or “tracks”, each typically having a title, separate and apart from the CD title and a track number. The nature of digital storage and MP3 recording technology facilitates the generation of digital audio recordings for storage and access from a random access memory media, such as a hard disc drive. The ability to selectively generate digital audio recordings, including MP3 files, permits a user to assemble a collection of audio recordings composed of not only entire albums or CD's, but indeed, individual songs or tracks from such albums or CD's whereby a collection may not include all of the songs or tracks from any individual CD. The nature of the Internet and changes in music publishing and distribution has lead to record labels making one or more songs or tracks from a CD freely available to the public in digital form for downloading from the Internet. As such, a user's collection may include such lawfully acquired single tracks, the album title, artist and other parameters for which are similarly available.

One significant drawback to the typical prior art database management tool, and in particular, audio and/or video media object managers is their reliance upon a primarily textual interface which while able to identify a whole CD or just a single song, is unable to convey to the user that other songs exist in the CD, songs which are not in the user's collection. While playlists and queues are provided for in a typical prior art audio media object manager, the text based system requires often detailed reading and manipulation to ascertain the status of the playlist or queue and does not lend itself to easy use.

Accordingly, a need exists for an improved user interface that allows a user to quickly and easily view the contents and completeness of a media object library. A need also exists for a user interface that presents information concerning media objects in a manner that readily conveys to the consumer aspects of the collection and facilitates the user's ability to acquire missing objects.

### SUMMARY OF THE INVENTION

In accordance with these and other needs, a method for managing the contents of a collection of media objects each having one or more identifying parameters is described. An image representative of a media object within the collection of media objects that is determined to have one or more specified identifying parameters is displayed. An image representative of a media object determined to be missing from the collection of media objects that is known to have the one or more specified identifying parameters is also displayed. In this manner, for example, a consumer may be informed of a need to add the media object determined to be missing from the collection of media object to the media object library. A method is also described for managing a queue of media objects for access by an electronic device. To this end, images representative of the media objects within the queue are displayed and the image representative of a media object within the queue that is presently being accessed by the electronic device is highlighted.

A better understanding of the objects, advantages, features, properties and relationships of the graphical user interface will be obtained from the following detailed description and accompanying drawings which set forth illustrative embodiments which are indicative of the various ways in which the principles of the graphical user interface may be employed.

### BRIEF DESCRIPTION OF THE DRAWINGS

For a better understanding of the graphical user interface, reference may be had to preferred embodiments shown in the following drawings in which:

FIG. 1 illustrates an exemplary device for accessing media objects in the form of an MP3 player having a graphical user interface constructed in accordance with the principles of the subject invention;

FIG. 2 illustrate an exemplary graphical user interface page for managing the contents of a collection of media object; and

FIG. 3 illustrates an exemplary graphical user interface page for viewing and managing a collection of media objects queued for access by an electronic device.

### DETAILED DESCRIPTION

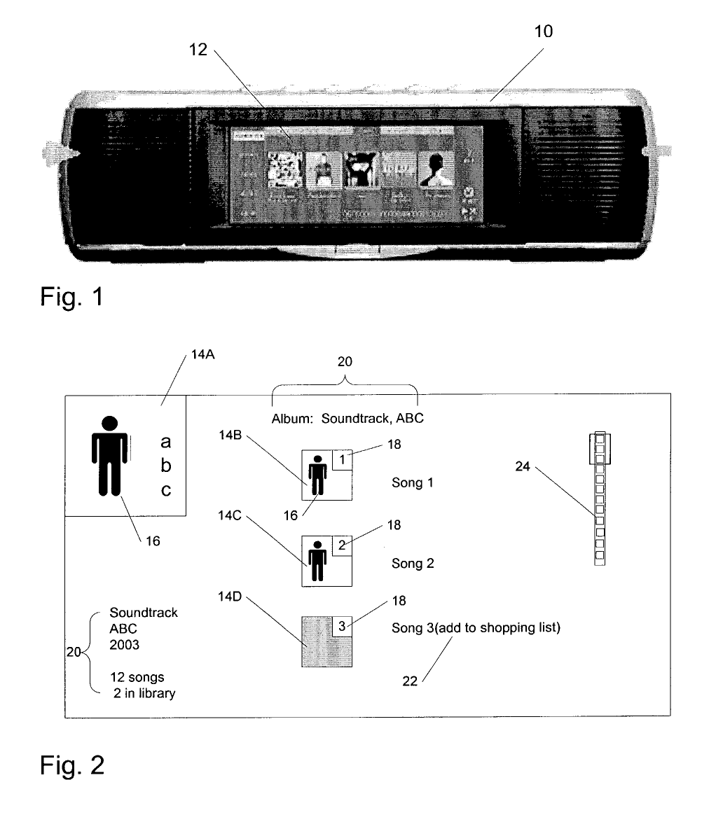

Referring now to the figures, wherein like reference numerals refer to like elements, a graphical user interface for managing the contents of a collection of media objects is described. In the description that follows, it is to be understood that media objects comprise, by way of example, digitally stored images, digitally stored audio or video recordings, and/or broadcast content such as television, radio, or streaming data, individually or as a compilation, for example, by being related according to genre, sub-genre, artist, album, play list, etc. It is to be further understood that the graphical user interface described hereinafter is contemplated for use in connection with a microprocessor based electronic device 10 to command the electronic device 10 to play or otherwise process one or more of the media objects. To this end, the microprocessor based electronic device 10, for example, an MP3 player as illustrated in FIG. 1, may include an integrated or detachable display 12 that is used to present the graphical user interface to a consumer. Alternatively, the graphical user interface could be displayed to the consumer in a further electronic device that is remote from the electronic device 10, for example, a television, a monitor screen, a remote control, or the like, that is adapted to communicate with the electronic device 10. Interaction with the graphical user interface, whether local or remote to the electronic device 10, is accomplished using conventional graphical user interface devices, such as a mouse, keyboard, wireless pointer, touch screen, or the like.

For use in the managing of a collection of the media objects, the electronic device that supports the graphical user interface is provided with access to a database in which is maintained parameters by which individual elements of the collection of media objects are identifiable. By way of example, parameters that are used to identify one or more of the media objects may include global titles (e.g., album or movie titles), track titles, artist/actor names, distributor information (e.g., label information), beats per minute, run time, credits, year recorded or published, genre, metagenre, subgenre, languages, notes, etc. In the case of digitally stored audio files, the parameters may correspond to ID3 data. As will be appreciated, ID3 data is typically attached to a digitally stored audio file to carry information relevant to that digitally stored audio file such as, by way of example, title(s), artist(s), track information, year of publication, genre, and/or comments. As used herein, media objects can comprise single tracks, compilations or other media objects.

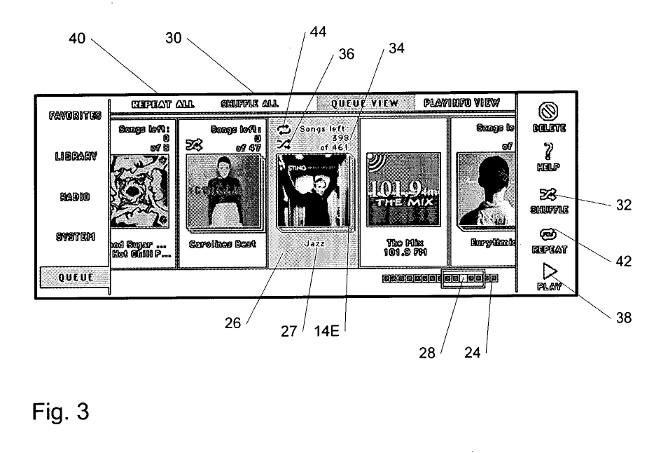

For use in quickly identifying a unique or logical group of media objects to assist in the management of the media objects, media objects are represented within the graphical user interface using images 14 as illustrated in FIGS. 2 and 3. Preferably, each image 14 provides a visual and/or textual indication as to the one or more of the parameters that are associated with the media object the image 14 represents. For example, an image 14 may take the form of the actual visual image that appears on the physical album cover or CD jewel box from which its corresponding media object originated. Since the actual visual image that appears as cover art on an album, movie, book, etc. is typically unique, such images are desirable as they function to identify the parameters of a media object, i.e., its title, artist/author, etc., without the need for any textual indicia. By way of example, FIG. 2 illustrates images 14A-14C having a common feature 16, e.g., a cover art image, the use of which allows the consumer to discern that the media objects represented by the images 14A-14C have at least the parameters album, artist, and date of publication in common.

To allow a user to further distinguish between images 14 that have a common feature 16, the images 14 may be provided with further image or textual indicia 18 the content of which serves to identify one or more parameters that, in turn, allows the user to identify a unique media object represented by that image 14. It will also be appreciated that the absence of any indicia 18 may also serve to uniquely identify a represented media object. By way of example, FIG. 2 illustrates indicia 18 in the form of a colored rectangular box having a number which indicia 18 is used to provide album track parameter information to the consumer. Thus, using the example illustrated in FIG. 2, image 14A, which fails to include the indicia 18, may be used to represent a media object comprising the whole of an album, i.e., a compilation of album tracks, image 14B, which includes indicia 18 having a visible “1,” may be used to represent a media object comprising track number one from the album represented by the image 14A, and image 14C, which includes indicia 18 having a visible “2,” may be used to represent a media object comprising track number two from the album represented by the image 14A. As will be apparent from FIG. 2, it is preferred that the indicia 18 not obscure the common feature 16 of the images 14 thus allowing the consumer to use the common feature 16 to easily identify the parameter(s) that are common between the media objects represented by the images 14.

To provide the images 14 that will be associated with the media objects, which images 14 would also be maintained within the database, it is contemplated that the consumer can load an image 14 into the system, for example, by uploading a scanned original album cover or CD jewel box insert, a bitmap image, etc. Where cover art is not available or the user elects not to use uploaded art, a generic image can be provided by the graphical user interface. In keeping with the desire to identify individual and logical groups of media objects, a generic image can be selected and/or edited to convey one or more dominant parameters of the media object it is to represent within the graphical user interface as well as parameters that are unique to the media object. Unique parameters, such as track parameter information, may be automatically inserted into an image 14 as indicia 18 when appropriate. To this end, the system may be adapted to examine and use, for example, ID3 data to create the indicia 18 that is to be provided to an image 14. The graphical user interface may also allow for the manual insertion of textual or graphical indicia into an image 14 for the purpose of identifying one or more parameters. It will be further appreciated that the system may be configured to allow for the automatic of manual association of an image 14, whether uploaded or generic, with a corresponding media object. In this manner, once a media object has been associated with an image 14, an electronic device may be commanded to access the media object, e.g., to play, delete, move, organize, etc. a media object, by using the graphical user interface to interact with its associated image 14.

The database in which the parameters and images are maintained may be local to the electronic device that supports the graphical user interface and/or maintained on one or more servers remote to the electronic device. By way of example, the database may be stored in a PC, hard drive array, network, or one or more remote computers accessible via the Internet with which the electronic device is adapted to communicate. It will also be appreciated that the collection of media objects may be maintained within this same database, especially in the case where the electronic device that supports the graphical user interface is also adapted to provide access to the media objects.

To manage a collection of the media objects, the graphical user interface provides the consumer with the ability to display a logical view of the contents of a media object library, i.e., media objects that are stored within an accessible database or are otherwise freely accessible within a network including the electronic device. In this regard, the logical view functions to display a view of the images 14 for those media objects in the media object library that are determined to have one or more parameter in common. The parameter(s) used in forming the logical view may, of course, be set by default of be user selectable.

By way of specific example, FIG. 2 illustrates a logical view of the media object library where the selected parameter(s) are associated with a specific album. Within this logical view, the consumer may be presented with an image 14A that is representative of the specified album object as well as images 14B-14C that are representative of individual tracks for that album, i.e., the track media objects that the album media object is a compilation of. In the illustrated example, images 14B-14C are displayed so as to make clearly visible the common element 16 to thereby represent to the consumer that the corresponding media objects may be found within the media object library. The logical view may also present an image 14D that functions to represent a media object having the specified parameter(s) that is determined to be missing from the media object library. The image 14D that represents a missing media object may be presented with the common element 16 grayed, faded, missing, etc. to readily indicate to the consumer that it is missing from the media object library. When appropriate, the image 18D may also display indicia 18 to thereby provide to the consumer more specific information regarding the media object that is determined to be missing. Thus, in the illustrated example, image 14D functions to inform the consumer that the third track media object for the specified album media object was determined to be missing from the media object library while images 14B and 14C function to inform the consumer that the media object library did include the first and second track media objects for the specified album media object. The logical view may also provide a means 22 to access a Web site or the like, for example via a link to an Internet Website, to allow any media objects determined to missing from the media object library to be purchased, downloaded, or otherwise included in the media object library. In the example illustrated the user is given the ability to update a separately maintained database referred to as a shopping list whereby the user can tag a missing song thereby adding it to a list for later recall when, for example, a user goes shopping.

As will be appreciated, in the case of at least audio media objects, ID3 is data may be examined to determine the number of images 14 that are to be displayed within a logical view and how to display the images, i.e., the ID3 data may also be used to determine if track media objects for a specified album media object are found in or missing from the media object library. It will be further appreciated that the logical view may include textual information 20 that similarly functions to identify one or more parameters relevant to the logical view, such as, the media object type, e.g., “album,” genre, e.g., “soundtrack,” title, e.g., “ABC,” year of publication, e.g., “2003,” number of total tracks for the title, e.g., “12,” and/or number of total tracks for the title within the library, e.g., “2.”

In the case where the number of images 14 within the logical view exceeds the capacity of the display, the graphical user interface may be adapted to accept input to scroll the display to thereby allow for the viewing of any off-display images 14. Such input may be made to the graphical user input by dragging a pointer along a touch screen, moving a scroll bar, or the like. A navigation element 24 may also be provided to display to the consumer which of the images 14 are presently viewable relative to all of the available images 14. It may also be desirable to allow the images 14 that are representative of the media objects that are found in a media object that is a compilation, e.g., an album, to be hidden or displayed in response to input from the consumer, for example, by the consumer toggling the graphical user interface by interacting with the image representative of the compilation, e.g., image 14A, and/or by interacting with another selectable icon presented within the graphical user interface.

From the logical view, or any other view of the media objects provided by the graphical user interface, media objects may be selected for access by an electronic device, for example, to be played individually or from a queue. In the case where queued access is available, the graphical user interface should also provide a means for viewing and interacting with the queue whereby the consumer may edit the queue, for example, by dragging and dropping images to change the order in which their corresponding media objects are accessed, to remove media objects from the queue, and/or to add additional media objects to the queue. Within the queue, a media object may itself comprise a compilation of playable media objects, such as the “Jazz” genre compilation represented by image 14E shown in a queue view which is illustrated by way of example in FIG. 3. Access to a queue of media objects by an electronic device may be turned on and off, for example, by interacting with a “play” icon 38.

For displaying to the consumer which of the media objects from a queue of media objects is currently being accessed by the electronic device, the queue view may highlight the image 14 that corresponds to that media object. By way of example, with reference to FIG. 3, highlighting may be accomplished by providing, for example, a colored border 26 that surrounds the image 14 representative of the media object that is currently being accessed. The queue view may also display textual parameter information 27 in the border 26 to provide the consumer with further information regarding the media object represented by the image 14. Images shown to one side of the highlighted image may represent media object that have already been accessed while images shown to the other side of the highlighted image may represent media object that have yet to be accessed, in the case where access is linear. When a media object is a compilation of playable media objects, the queue view may also provide additional indicia, such as a textual label 34, that notifies the consumer as to how many media objects from the compilation remain to be accessed. For a global view, a navigation element 24 may be provided to display to the consumer, using highlighting 28, which media object relative to all of the media objects within the queue is presently being accessed. The navigation element 24 may also provide to the consumer a view that allows the consumer to discern which of the images are presently being displayed relative to all of the images available within the queue view. In this regard, the images that are displayed may be a function of which of the media objects is presently being accessed. When the queue is being managed, the navigation element 24 will display the present scroll position of the images 14.

The queue view may also provide the consumer with the ability to manage how the media objects within the queue are being accessed, for example, to command that the media objects be accessed in a shuffled order. Shuffling can occur on a global level where the order in which media objects are accessed is random, a local level where the order in which media objects of a compilation media object, such as the “Jazz” media object represented by image 14E, are accessed at random, or a combination thereof. When global shuffling is activated and local shuffling of a compilation media object is not desired, the media objects of a compilation media object within the queue will play in a linear order while the order in which that compilation media object is accessed will be random. To request global shuffling, the consumer may activate a graphical user icon such as the “shuffle all” icon 30. For informing a consumer that global shuffling has been activated, the “shuffle all” icon 30 may be highlighted. To request local shuffling, the consumer may select an image 14 representative of a compilation media object and thereafter select the “shuffle” icon 32. To inform a consumer when local shuffling of a compilation media object is activated, the queue view may display a “shuffle” icon 36 in a manner that associates the icon 36 with the image 14 representative of the media object to which this operation has been applied.

Still further, the queue view may provide the consumer with the ability to command that access to media objects be repeated. The repeated access of the media objects can occur on a global level, for example, by the consumer selecting the “repeat all” icon 40. For informing the consumer that global repeating has been activated, the “repeat all” icon 40 may be highlighted. Where repeated access on a local level is selected, for example by the consumer selecting a media object and thereafter selecting the “repeat” icon 42, only the selected media object is repeated which effectively eliminates the ability of the electronic device to access any of the other media objects remaining in the queue. To inform the consumer when a local repeating operation is enabled, the queue view may display a “repeat” icon 44 in a manner that associates the icon 44 with the image 14 representative of the media object to which this operation has been applied. It will be appreciated that media objects which rely upon streaming data, such as a radio station or the like, are not available to be locally shuffled or repeated. Rather, access to such media objects in a queue is typically governed by a time limit whether set by default or manually by the consumer.

While specific embodiments of the invention have been described in detail, it will be appreciated by those skilled in the art that various modifications and alternatives to those details could be developed in light of the overall teachings of the disclosure. For example, while described in the context of digitally stored recordings, those of skill in the art will appreciate that the graphical user interface described herein may be equally used to provide access to virtually any collection of content including, for example, a library maintained in an analog format (e.g., where an appropriate intermediary mechanism or jukebox serves to permit access to any content desired to be viewed or played). Accordingly, the particular arrangement disclosed is meant to be illustrative only and not limiting as to the scope of the invention which is to be given the full breadth of the appended claims and any equivalents thereof.

What is claimed is:

1. A method for managing the contents of a collection of media objects each having one or more identifying parameters, the method comprising:
displaying a visual image representative of a media object within the collection of media objects determined to have one or more specified identifying parameters; and
displaying a visual image representative of a media object determined to be missing from the collection of media objects that is known to have the one or more specified identifying parameters.

2. The method as recited in claim 1, further comprising accepting user input to add the media object determined to be missing from the collection of media object to the media object library.

3. The method as recited in claim 1, further comprising displaying textual labels indicative of the one or more specified identifying parameters.

4. The method as recited in claim 1, wherein the collection of media objects comprises digitally stored audio recordings.

5. The method as recited in claim 4, wherein the identifying parameters comprise ID3 data associated with the digitally stored audio recordings.

6. The method as recited in claim 5, wherein the visual image representative of the media object within the collection of media objects determined to have one or more specified identifying parameters includes a cover art image and the visual image representative of the media object determined to be missing from the collection of media objects that is known to have the one or more specified identifying parameters includes a grayed version of the cover art image.

7. A method for managing the contents of a collection of media objects each having one or more identifying parameters, the method comprising:
displaying an image representative of a compilation media object that is a compilation of individual media objects, the compilation media object having one or more identifying parameters;
displaying an image representative of a first individual media object selected from the collection of media objects having the one or more identifying parameters associated with the compilation media object; and
displaying an image representative of a second individual media object determined to be missing from the collection of media objects that is known to have the one or more identifying parameters associated with the compilation media object.

8. The method as recited in claim 7, wherein the compilation media object is an album media object and the first and second individual media objects are album track media objects.

9. The method as recited in claim 7, wherein the image representative of the first individual media object has at least a first image element that is also included in the image representative of the compilation media object.

10. The method as recited in claim 9, wherein the image representative of the second individual media object also includes at least the first image element.

11. The method as recited in claim 10, wherein the first image element in the image representative of the second individual media object is grayed.

12. The method as recited in claim 9, wherein the image representative of the first individual media object has a second image element that distinguishes the image representative of the first individual media object from the image representative of the second individual media object.

13. The method as recited in claim 12, wherein the compilation media object comprises an album media object, the first and second individual media objects comprise album track media objects, the first image element comprises a cover art image, and the second image element is representative of an album track number.

14. The method as recited in claim 13, further comprising displaying textual labels indicative of the identifying parameters of the compilation media object.

15. The method as recited in claim 13, wherein the identifying parameters comprise ID3 data.

16. The method as recited in claim 7, further comprising accepting user input to add the second individual media object to the media object library.

17. A method for managing a queue of media objects for access by an electronic device, the method comprising:
displaying images representative of the media objects within the queue; and
highlighting the image representative of a media object within the queue that is presently being accessed by the electronic device.

18. The method as recited in claim 17, wherein the images representative of the media objects within the queue exceed the area of a display and wherein a navigation guide is provided to illustrate which images are viewable relative to all of the images.

19. The method as recited in claim 18, wherein the images viewable in the display are centered around the highlighted image.

20. The method as recited in claim 19, wherein images to one side of the highlighted image represent media objects in the queue that have already been accessed by the electronic device and images on an opposite side of the highlighted image represent media object in the queue that have yet to be accessed by the electronic device.

21. The method as recited in claim 20, further comprising accepting user input to toggle on and off access to the queue of media objects by the electronic device.

22. The method as recited in claim 18, wherein the highlighted image is also highlighted within the navigation guide.

23. The method as recited in claim 18, further comprising displaying textual information related to parameters associated with the media objects.

24. The method as recited in claim 18, wherein highlighting the image representative of a media object within the queue that is presently being accessed by the electronic device comprises providing a colored border about the image.

25. A method for managing a queue of media objects for access by an electronic device where the queue of media objects includes at least one compilation media object comprised of a plurality of individual media objects, the method comprising:
displaying images representative of the media objects within the queue;
allowing a user to select that the queue of media objects be accessed in a shuffled order; and
allowing a user to select that the plurality of individual media objects comprising the compilation media object be accessed in a shuffled order.

26. The method as recited in claim 25, wherein allowing a user to select that the queue of media objects be accessed in a shuffled manner further comprises accepting user input via a touch screen that functions to activate a global shuffle graphical user interface elements.

27. The method as recited in claim 26, wherein allowing a user to select that the plurality of individual media objects comprising the compilation media object be accessed in a shuffled order further comprises accepting user input via the touch screen display that selects the image representative of the compilation media object and user input via the touch screen that functions to activate a local shuffle graphical user interface element to effect local shuffling of the compilation media object represented by the selected image.
